(19) United States
(12) Patent Application Publication
(10) Pub. No.: US 2009/0126155 A1
(43) Pub. Date: May 21, 2009

(54) Coupling assembly for a foldable electronic device

(75) Inventors: John B. Van Den Nieuwenhuizen, Chicago, IL (US); Mark D. Janninck, Glen Ellyn, IL (US); Claudio Santiago Ribeiro, Evanston, IL (US); Dan Berg, Libertyville, IL (US)

Correspondence Address: The Watson Intellectual Property Group, PLC;[Motorola], 3133 Highland Drive, Suite 200, Hudsonville, MI, 49426, US

(73) Assignee: Motorola, Inc.

(21) Appl. No.: 11/985,663

(22) Filed: Nov. 16, 2007

(51) Int. Cl. E05D 7/00

(52) U.S. Cl. 16/302

(57) ABSTRACT

A foldable electronic device comprising a first and second housing element and a coupling assembly, including a linkage assembly and a biasing member, that directs the housing elements between a closed and a deployed orientation. The linkage assembly includes a plurality of adjacently disposed links collectively defining a first end and a second end. The first end is coupled to the first housing element and the second end is coupled to the second housing element. Each link is rotatably coupled to each adjacently disposed link and includes an outward limiting member limiting the relative rotation of adjacent links in an outward direction of rotation. The biasing member is coupled to the housing elements and outwardly biases the housing elements relative to each other to direct rotation of the housing elements toward the deployed orientation. The operable length of the biasing member changes as the housing elements are rotated toward the deployed orientation.

### BACKGROUND

1. Field of the Disclosure

The disclosure relates in general to a foldable electronic device, and more particularly, to a foldable electronic device having a coupling assembly which facilitates the articulation of the foldable electronic device between a closed orientation and a deployed orientation.

2. Background Art

The use of foldable electronic devices, such as cellular telephones, and the like has steadily increased. Typically, the foldable electronic devices include a first housing element and a second housing element which are in some manner coupled together so as to permit rotation of the housing elements relative to each other. As a result, the housing elements can be rotated between a closed orientation and a deployed orientation. For example, the device can be stored and maintained in the closed orientation when not in use and then deployed for use.

A number of different manners in which to couple two housing elements of an electronic device have been employed. Among other structures, a single axis hinge, possibly with damping features is often used to couple the housing elements. In other structures, complex hinge mechanisms with multiple springs and components is utilized. Often, such complex structures are difficult and/or expensive to manufacture. Furthermore, regardless of complexity, many of the hinges lack the robustness necessary for extended and frequent articulation. Indeed, with many devices the hinge may be the source of failure in the foldable electronic device, while the electronic components continue to function without issue.

Accordingly, what is needed is a coupling assembly which facilitates articulation of a foldable electronic device between a closed orientation and a deployed orientation which overcomes the prior art deficiencies.

### SUMMARY OF THE DISCLOSURE

The disclosure is directed to a foldable electronic device, such as a cellular telephone. It will be understood that the invention is not limited to a cellular telephone, and may be utilized with other types of foldable electronic devices. The foldable electronic device includes a first and second housing element. A coupling assembly directs the first and second housing elements between a closed orientation and a deployed orientation. The coupling assembly includes a linkage assembly and a biasing member.

The linkage assembly includes a plurality of adjacently disposed links which collectively define a first end and a second end. The first end is coupled to the first housing element and the second end is coupled to the second housing element. Each link is rotatably coupled to each adjacently disposed link and includes an outward limiting member limiting the relative rotation of adjacent links in an outward direction of rotation.

The biasing member is coupled to the first and second housing elements. The biasing member outwardly biases the housing elements relative to each other so as to direct rotation of the housing elements about the linkage assembly toward the deployed orientation. The operable length of the biasing member changes as the housing elements are rotated relative to each other toward the deployed orientation.

In at least one embodiment, each link includes an inner surface and an outer surface so as to define a thickness. A hinge is positioned between two adjacent links proximate the inner surface thereof. The outward limiting member comprises a wall on each of the two adjacent links extending outboard of the hinge. Each link may have a different length. Additionally, any number of links are contemplated, such as, for example, four links.

In at least one embodiment, the links are of a substantially uniform width which is structurally configured to minimize the torsional rotation of the housing elements relative to each other.

The links limit the rotation of the housing elements relative to each other such that in the deployed orientation the housing elements are angled at approximately between 150 and 165 degrees. Of course, the angle at which the housing elements are disposed is not limited to the foregoing range.

In at least one embodiment, the biasing member comprises an elongated cantilever spring member having a first end fixed to one of the housing elements and a second end which is slidably coupled to the other housing element.

In at least one embodiment, the biasing member includes an assistant biasing member which is coupled to the elongated cantilever spring member at the second end thereof and to the respective housing element. The assistant biasing member biases the second end of the elongated cantilever spring member relative to the respective housing element to assist the rotation of the housing elements in the direction of the deployed orientation.

In at least one such embodiment, the elongated cantilever spring member includes one or more side edge surface configurations which define a cam. In turn, the biasing member comprises at least one compression spring having a first end coupled proximate the second end of the elongated cantilever spring member, and a second end which defines a follower that is directed against the cam.

In at least one embodiment, the biasing member comprises a torsional member, such as a torsional spring, and a flexible material. The torsional member has a first end fixed to one of the housing elements. The second end is coupled to the flexible material at a proximal end thereof. The distal end of the flexible material is coupled to the other housing element. The torsional member biases the flexible material to rotate the first housing element relative to the second housing element toward the deployed orientation, as the flexible material is wound upon itself about the axis of rotation of the torsional member.

In at least one embodiment, the biasing member comprises a torsional member fixed at one end to one of the housing elements and a second end coupled to a pinion. The other housing element includes a rack coupled thereto. The rack corresponds to the pinion, such that the torsional member biases the pinion to translate the rack, and in turn, rotate the housing elements toward the deployed orientation.

In at least one embodiment, a closure assembly is provided. The closure assembly includes a first closure member disposed on the first housing element and a second closure member disposed on the second housing element. The first closure member is positioned so as to releasably engage the second closure member upon rotation of the housing elements toward and into a closed orientation. The cooperation between the closure members is sufficient to oppose the biasing member and to releasably maintain the housing elements in a closed orientation.

In at least one such embodiment, the closure members comprise magnets. In another such embodiment, the closure members comprise a latch member and a corresponding post member.

### BRIEF DESCRIPTION OF THE DRAWINGS

The disclosure will now be described in detail with reference to the drawings wherein:

FIG. 1 of the drawings is a perspective view of an embodiment of the foldable electronic device in a deployed orientation;

FIG. 2 of the drawings is a partial cross-sectional view of an embodiment of the foldable electronic device, showing, in particular, the coupling assembly thereof;

FIG. 3 of the drawings is a partial bottom plan view of an embodiment of the foldable electronic device, showing, in particular, one embodiment of the biasing member;

FIG. 4 of the drawings is a partial perspective view of an embodiment of the linkage assembly of the present invention;

FIG. 5 of the drawings is a cross-sectional view of an embodiment of the foldable electronic device in the closed orientation;

FIGS. 6a through 6c of the drawings are a sequential schematic representation of the linkage assembly extending from a closed orientation to a deployed orientation;

FIG. 7 of the drawings is a partial cross-sectional view of an embodiment of the foldable electronic device, showing, in particular, one embodiment of the biasing member, showing, in particular, a second elongated cantilever member;

FIG. 8 of the drawings is a bottom plan view of an embodiment of the biasing member of the present invention;

FIG. 9 of the drawings is a bottom plan view of an embodiment of the biasing member of the present invention;

FIG. 10 of the drawings is a bottom plan view of an embodiment of the biasing member of the present invention;

FIG. 11 of the drawings is a side elevational view of an embodiment of the linkage assembly of the present invention; and

FIG. 12 of the drawings is a front elevational view of an embodiment of the foldable electronic device, showing, in particular, an embodiment of the coupling assembly.

### DETAILED DESCRIPTION OF THE DRAWINGS

While susceptible of embodiment in many different forms, there is shown in the drawings and described herein in detail a specific embodiment with the understanding that the present disclosure is to be considered as an exemplification of the principles of the disclosure and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

Referring now to the drawings and in particular to FIG. 1, foldable electronic device is shown generally at 10. The foldable electronic device may comprise a wireless device, such as, for example a cellular telephone. Of course, the invention is not limited to such a device. The device 10 includes first housing element 12, second housing element 14, coupling assembly 16 and closure assembly 18. It will be understood that the first housing element is rotated relative to the second housing element to direct the device between a closed orientation and a deployed orientation.

First housing element 12 includes inward surface 20, outward surface 22, proximal end 24, distal end 26 and opposing side edges 28, 29. Furthermore, first housing element includes microphone 46 and keyboard 42 on inward surface 20. It is contemplated that the first housing element can rotate about a longitudinal axis such that the inward surface may become the outward surface upon rotation, and such that the outward surface becomes the inward surface upon such rotation.

Second housing element 14 includes inward surface 30, outward surface 32, proximal end 34, distal end 36 and opposing side edges 38, 39. In the embodiment shown, the second housing element 14 includes speaker 48 along with display 40. It is contemplated, as with the first housing element, the second housing element may be rotated about a longitudinal axis such that the inward surface may become the outward surface upon rotation, and such that the outward surface becomes the inward surface upon such rotation.

Additionally, each of the first housing element and the second housing element typically includes a plurality of electronic components. With reference to FIG. 2, a plurality of wires 33 may extend between the first housing element and the second housing element to connect the various electronic components to each other. Often times, such wires may be coupled together so as to resemble a ribbon formed from joined, parallel side by side wires.

Coupling assembly 16 includes linkage assembly 50 and biasing member 52. The coupling assembly controls the movement of the first and second housing elements relative to each other between the deployed orientation and the closed orientation. A number of different embodiments of the coupling assembly will be described below.

More specifically, one embodiment of the coupling assembly is shown in FIGS. 2 through 5. The linkage assembly 50 of the coupling assembly includes a plurality of links that are rotatably connected to each other about a plurality of hinges disposed between adjacent links. In the embodiment shown, a total of four links are utilized, namely, a pair of end links 54a, 54d which are coupled at the outer end thereof to a respective housing element, and, a pair of intermediate links 54b, 54c. It will be understood that a greater or lesser number of intermediate links may be utilized between the end links that are attached to the housing elements.

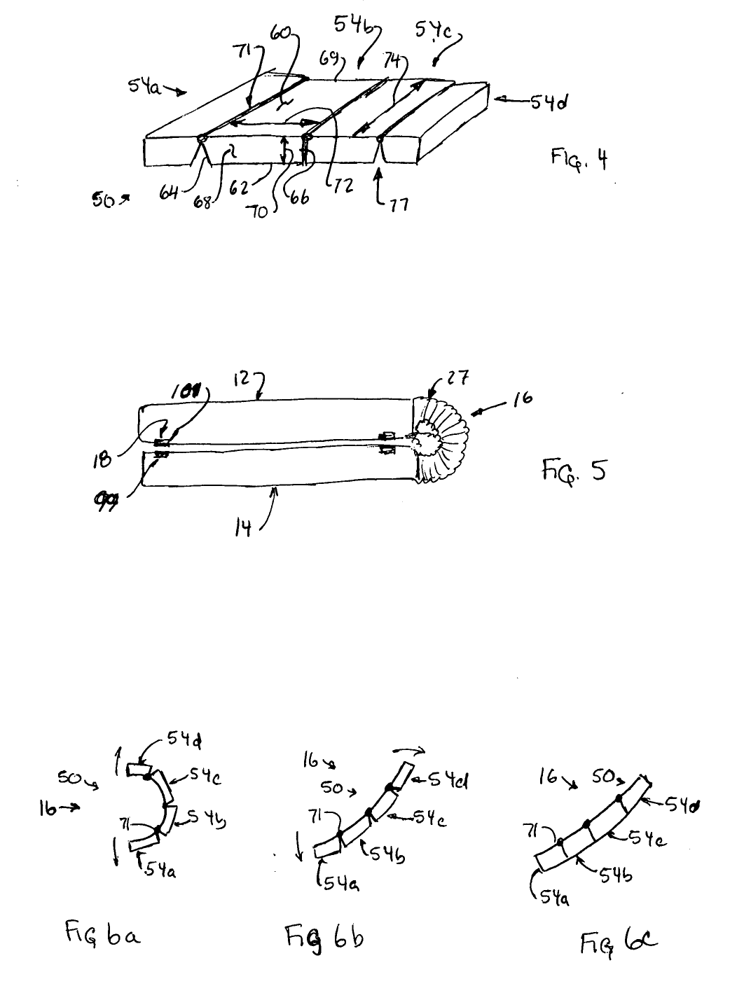

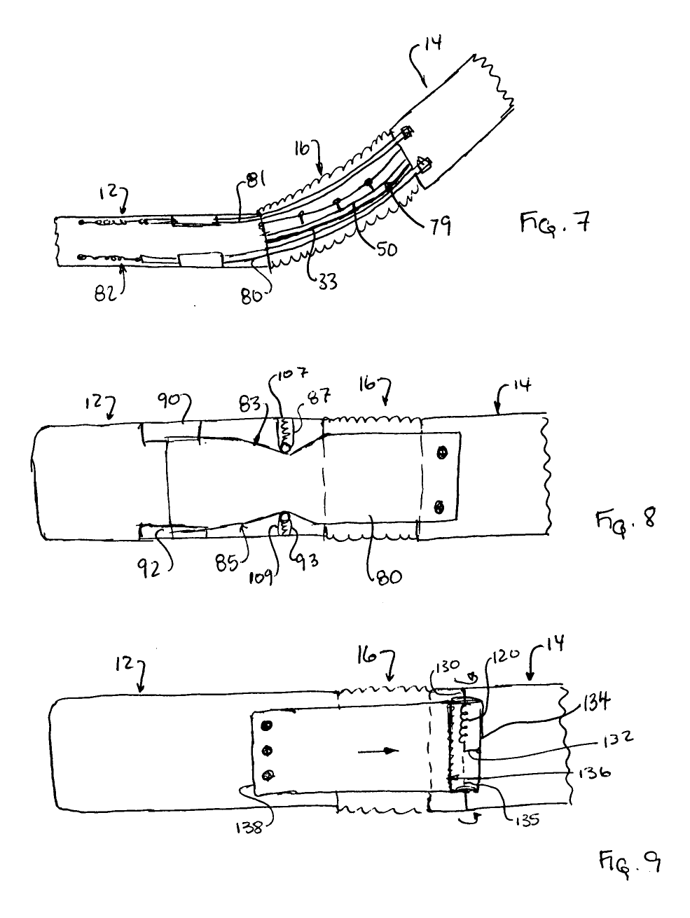

With reference to FIG. 4, each of the intermediate links 54b, 54c include inner surface 60, outer surface 62, opposing walls 64, 66 and opposing end walls 68, 69. These various walls and surfaces define thickness 70, length 72 and width 74. With particular reference to FIGS. 2 and 4, the links are connected to each other by way of hinges 71. The hinges are positioned toward the inner surface 60 of the corresponding links. Accordingly, as the hinges are rotated, eventually corresponding walls make contact and preclude further rotation. In turn, these wall portions cooperate to form outer limiting members 77 which limit further rotation of the hinges. FIGS. 6a through 6c disclose the link movement between the closed orientation and the open orientation.

It will be understood that the thickness and the length of the links can be altered so as to achieve different movement and limiting of each link vis-à-vis another link. For example, and as is shown in FIG. 4, certain of the opposing walls 64, 66 have varying angular dispositions relative to the outer surface 60 and inner surface 62. Also with reference to FIG. 4, the length of the different links can be varied, wherein each link may have a different length. Additionally, it will be understood that the length of the links and the width of the elongated cantilever spring member are structurally configured to substantially limit the torsional flexing of the coupling assembly and the ability to torsionally rotate the first housing element relative to the second housing element.

In another embodiment, and with reference to FIG. 11, the position of the hinge may be varied such that the wall portion between the hinge 71 and the inner surface 60 of adjacent links may define an inward limiting member 69 which limits further inward rotation of the first housing element relative to the second housing element.

The end links 54a and 54d may be substantially the same as the intermediate links, that is, the end links may be hingedly coupled to the respective one of the first and second housing element. In other embodiments, these end links may be fixedly coupled to the respective one of the housing elements.

In the present embodiment, the fully deployed orientation, defined by the point at which the respective walls contact each other and limit further outward rotation, results in an angular disposition of approximately 160 degrees between the first housing element and the second housing element. Of course, in different embodiments, the first housing element and the second housing element can be disposed at a number of different angles, such as between 150 and 165, or at angles of less than 150, greater than 160 or even 180 degrees. Indeed, the invention is not limited to any particular angular disposition in the fully deployed orientation.

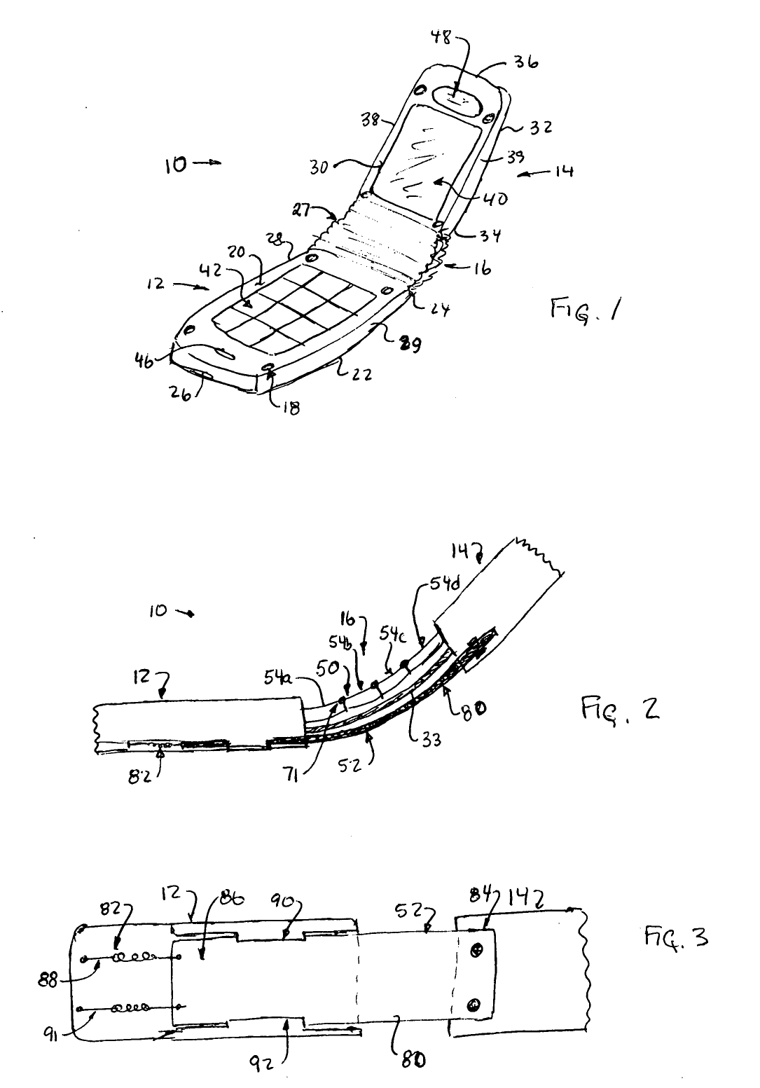

The biasing member 52 is shown in FIGS. 2 and 3 as comprising elongated cantilever spring member 80, and assistant biasing member 82. The elongated cantilever spring comprises a spring steel member (in the present embodiment) that can be elastically deformed through bending. Thus, the elongated cantilever spring member, in an unflexed orientation may be substantially planar, wherein it may be elastically deformed into a substantially “u” shaped configuration (FIG. 5). Due to internal biasing, the elongated cantilever spring member is biased toward the unflexed orientation.

With reference to FIG. 3, the elongated cantilever spring member comprises a first end 84 and a second member 86. The first end 84 is generally fixed to the second housing element 14. The second end 82 is slidably coupled to the first housing element 12. More specifically, the outward surface 22 of the first housing element 12 includes opposing slots 90, 92 along which the elongated cantilever spring member can slide. It will be understood that as the elongated cantilever spring member slides within the opposing slots, the operable length of the spring member changes as the operable length of the spring is that portion of the spring between the fixed first end and the biased portion of the second end (i.e. the portion which is not disposed within or beyond the opposing slots 90, 92).

In certain embodiments, such as the embodiment shown in FIG. 3, it may be desirable to enhance the return of the elongated cantilever spring member to an unflexed orientation (thus directing the foldable electronic device 10 into a deployed orientation). In such embodiments, assistant biasing member 82 may be employed. In the embodiment shown, the assistant biasing member 82 comprises a pair of spring members 88, 91. Each of the spring members are coupled to the second end of the elongated cantilever spring member and to the first housing element 12. The spring members are configured to pull the second end of the elongated cantilever spring member through the opposing slots 90, 92 so as to assist with the shortening of the operable length of the elongated cantilever spring member. In turn, the speed at which the electronic device reaches the deployed orientation is increased.

It will be understood that while the assistant biasing member is shown as comprising a compression spring, extension springs, torsional springs, among others are likewise contemplated for use.

In one particular embodiment, and with reference to FIG. 8, the elongated cantilever spring member 80 includes cam surfaces along one or both of the opposing side edges 83, 85. The assistant biasing member may comprise a follower operating against the cam surface. In the embodiment shown, a pair of opposing followers 87, 93 are inwardly biased by spring members 107, 109 against the respective one of the cam surfaces 83, 85. The profile is such that the followers force slidable movement of the cam surfaces, according to the profile of the cam. By configuring the cam surfaces, the followers enhance the speed and the force with which the phone is directed to the deployed orientation.

Another embodiment is shown in FIG. 7, wherein a second elongated cantilever spring member 81 may be employed. The second elongated cantilever spring member 81 is fixed to one of the first housing element and the second housing element, and slidably movable relative to the other in a fashion similar to the elongated cantilever spring member. The two elongated cantilever spring members are separated from each other so as to define a gap 79. In certain such embodiments, the linkage assembly 50 can be positioned within the gap, along with, for example the electrical ribbon wiring 33 between the two housing elements. In other embodiments, no additional components are positioned between the two elongated cantilever spring members. The plurality of elongated cantilever spring members provides additional biasing of the first housing element relative to the second housing element so as to increase the force directing the electronic device into the deployed orientation.

In another embodiment, shown in FIG. 9, the biasing means comprises torsional spring 120 and flexible material 122. The torsional spring is associated with the second housing element and includes first end 130 which is fixed to the second housing element, and a second end 132. The torsional spring has an axis of rotation 135.

The flexible material includes a first end 136 which is coupled to the second end 132 of the torsional spring (in certain embodiments an additional cylindrical member 134 may be disposed between the first end of the flexible material and the second end of the torsional spring so as to provide a surface upon which the flexible material may be wound). The flexible material further includes a second end 138 which is coupled to the first housing element.

In such an embodiment, the spring is biased such that in the deployed orientation, the spring is in a first lower tension and a portion of the flexible material is wound about the torsional spring. As the first and second housing elements are rotated relative to each other toward and into the closed orientation, the flexible material is unrolled, and, correspondingly, the tension in the torsional spring increases toward a second higher tension. When the closure assembly is overcome, the torsional spring pulls the flexible material so as to wind the same about the winding cylinder 134, until the electronic device is positioned in the deployed orientation, and the linkage assembly precludes further rotation. In another embodiment, the torsional spring may be replaced with a another torsional member which provides torsional force, such as a motor or cam hinge.

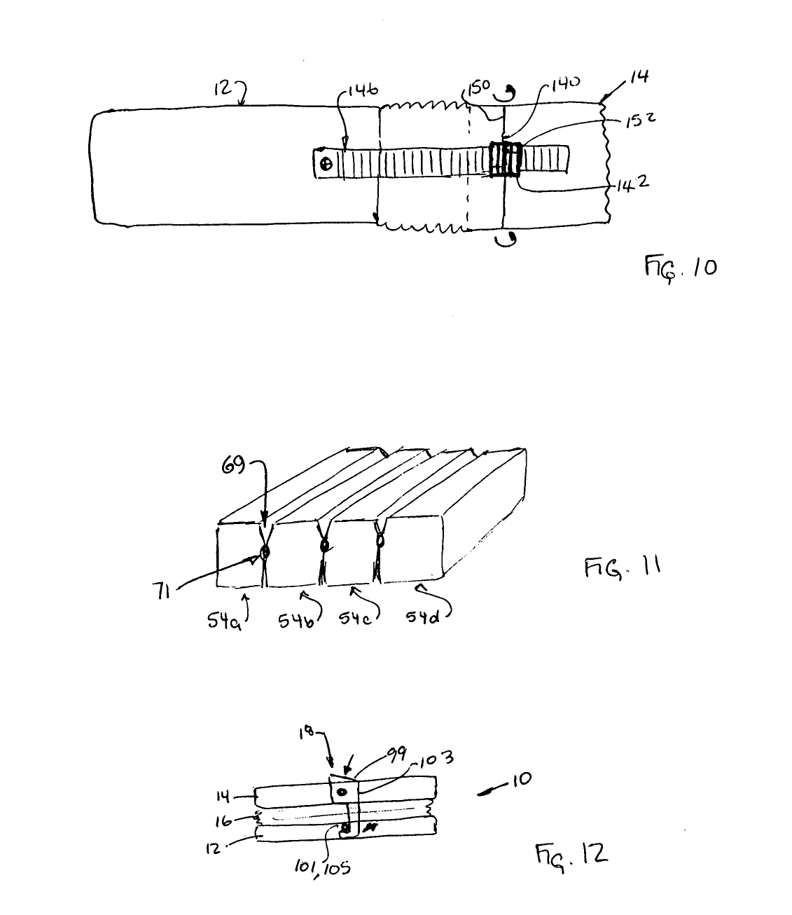

In yet another embodiment, as is shown in FIG. 10, the spring member may comprise a torsional spring 140 which includes first end 150 and second end 152. The first end is coupled to the second housing element 14. Pinion, such as pinion 142 is coupled to second end 152 of the torsional spring. Rack 146 which corresponds to pinion 142 is coupled to the first housing element 12. It will be understood that in a deployed orientation, the torsion spring is at a first lower tension. In turn, when the first and second housing elements are rotated relative to each other, the rack translates across the pinion and the pinion is rotated thereby. In turn, the pinion increases the tension on the torsional spring 140. Thus, in the closed orientation, the torsional spring is under a second higher tension.

As the user overcomes the closure assembly, the torsional spring directs the pinion to rotate, which translates the rack. As a result, the first and second housing elements rotate relative to each other toward the deployed orientation. The linkage assembly halts the rotation as the deployed orientation is reached. In another embodiment, the torsional spring may be replaced with a another torsional member which provides torsional force, such as a motor or cam hinge.

It will be understood that the foregoing embodiments are examples of the different biasing assemblies that are contemplated, and the examples are not intended to be limiting or an exhaustive of the different contemplated embodiments. They are intended to be several examples among a multitude of different biasing assemblies that are considered within the scope of the present disclosure. Furthermore, it will be understood that respective elements may be interchanged between the first and second housing elements. For example, in the embodiment of FIG. 10, the torsion spring and pinion may be positioned on the first housing element and the rack may be positioned on the second housing element.

With reference to FIG. 1 it will be understood that the coupling assembly may be covered by a conduit or flexible member 27 so as to provide an attractive appearance and so as to preclude damage to the coupling assembly. In the embodiment shown, a flexible tubular member is extended about the entirety of the coupling assembly that is positioned between the first and second housing elements.

The closure assembly 18 is shown in FIG. 5 as comprising first closure member 101 and second closure member 99. The first closure member is positioned on the first housing element 12 and the second closure member is positioned on the second housing element 14. The first closure member and the second closure member cooperate to maintain the electronic device in a closed orientation. It will be understood that the cooperation between the first and second closure members is greater than the force of the biasing member, such that absent an outside force upon the closure assembly, the electronic device will remain in a closed orientation.

In the embodiment shown, the first closure member comprises a plurality of magnets disposed about the first housing element 12. The second closure member comprises a plurality of magnets disposed about the second housing element 14. The magnets of the first housing element and the second housing element correspond and attract each other when the first and second housing elements are brought toward each other and into the closed orientation.

To overcome the closure assembly, the user can pull the first housing element and the second housing element relative to each other with a force greater than the attractive force of the opposing magnets. In other embodiments, one of the housing elements can slide relative to the other housing element (in the closed orientation) so as to disrupt the alignment of the magnets and to disengage same. Such configurations are shown in U.S. Pub. No. 2007/0067954 entitled “Hinge Apparatus and Methods Therefor” and U.S. Pub. No. 2006/0046792 entitled “Hinge Apparatus and methods Therefor,” the entire specification of each of the foregoing is hereby incorporated by reference in its entirety.

In other embodiments, such as the embodiment shown in FIG. 12, the closure assembly may comprise of a hook and tab configuration. For example, the first closure member 99 may comprise a latch member 103 which is positioned on the first housing element. The second closure 101 member may comprise a post 105. As such, the latch member 103 is configured to engage the post 105 when the electronic device 10 is in a closed orientation. When the latch member 103 is disengaged by the user, the first housing element and the second housing element rotate relative to each other as directed by the biasing member.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A foldable electronic device comprising:
a first housing element including an inward surface and an outward surface;
a second housing element including an inward surface and an outward surface; and
the first housing element coupled to the second housing element by a coupling assembly, the coupling assembly further comprising:
a linkage assembly comprising a plurality of adjacently disposed links collectively defining a first end and a second end, the first end is coupled to the first housing element and the second end is coupled to the second housing element to, in turn, enable relative rotation of the first housing element and the second housing element thereabout, each link is rotatably coupled to each adjacently disposed link, each link includes an outward limit member limiting relative rotation of adjacent links in an outward direction of rotation, whereupon engagement of the outward limit members precludes further rotation, defining a deployed orientation; and
a biasing member coupled to the first housing element and coupled to the second housing element, the biasing member outwardly biasing the first housing element relative to the second housing element so as to direct rotation of the first housing element relative to the second housing element about the linkage assembly toward the deployed orientation, wherein the biasing member includes an operable length which changes as the first housing element is rotated relative to the second housing element toward the deployed orientation.

2. The foldable electronic device of claim 1 wherein the first housing element further includes a microphone and the second housing element further includes a speaker.

3. The foldable electronic device of claim 1 wherein each link of the plurality of links includes an inner surface and an outer surface spaced apart from the inner surface so as to define a thickness, a hinge is positioned between two adjacent links of the plurality of links proximate the inner surface of each of the two adjacent links, the outward limiting member comprises a wall on each of the two adjacent links extending outboard of the hinge.

4. The foldable electronic device of claim 3 wherein each link of the plurality of links includes a length, wherein the length of at least one of the plurality of links is different than the length of another one of the plurality of links.

5. The foldable electronic device of claim 3 wherein the plurality of links comprises at least four links.

6. The foldable electronic device of claim 3 wherein the plurality of links includes a substantially uniform width, the width structurally configured so as to minimize torsional rotation of the first housing element relative to the second housing element.

7. The foldable electronic device of claim 1 wherein the first housing element is oblique to the second housing element at an angle of approximately between 150 and 165 degrees in the deployed orientation.

8. The foldable electronic device of claim 1 wherein the biasing member comprises an elongated cantilever spring member having a first end fixed to one of the first housing element and the second housing element, and a second end slidably coupled to the other of the first housing element and the second housing element.

9. The foldable electronic device of claim 8 wherein the biasing member further includes an assistant biasing member coupled to the elongated cantilever spring member at the second end thereof and to the one of the first housing element and the second housing element that is slidably coupled to the second end of the elongated cantilever spring member, the assistant biasing member biasing the second end of the elongated cantilever spring member relative to the one of the first housing element and second housing element to which the second end is coupled, to in turn, assist the rotation of the first housing element relative to the second housing element in the direction of the deployed orientation.

10. The foldable electronic device of claim 9 wherein the assistant biasing member comprises at least one of the group consisting of compression springs, extension springs and torsion springs.

11. The foldable electronic device of claim 10 wherein the assistant biasing member comprises at least one extension spring positioned at opposing sides of the second end of the cantilever spring member.

12. The foldable electronic device of claim 8 wherein the biasing member further comprises a second elongated cantilever spring member positioned in an overlaying configuration to the elongated cantilever spring member defining a gap therebetween, the foldable electronic device further comprising at least one electrical cable extending between the first housing element and the second housing element within the gap.

13. The foldable electronic device of claim 12 wherein the linkage assembly is positioned within the gap defined by the elongated cantilever spring member and the second elongated cantilever spring member.

14. The foldable electronic device of claim 8 wherein the elongated cantilever spring member further includes a side edge surface configuration defining a cam, the assistant biasing member comprises at least one compression spring having a first end coupled proximate the second end of the elongated cantilever spring member, and a second end defining a follower directed against the cam of the elongated cantilever spring member.

15. The foldable electronic device of claim 8 wherein the elongated cantilever spring member further includes opposing side edge surface configurations defining opposing cams, the assistant biasing member comprises opposing compression springs each having a first end coupled proximate the second end of the elongated cantilever spring member, and a second end defining opposing followers directed against a respective opposing cam of the elongated cantilever spring member.

16. The foldable electronic device of claim 1 wherein the biasing member comprises a torsional member and a flexible material, the torsional member has a first end fixed to one of the first housing element and the second housing element, and a second end coupled to the flexible material having a proximal end coupled to the second end of the torsional member and a distal end spaced apart and coupled to the other of the first housing element and the second housing element, the torsional member biasing the flexible material so as to rotate the first housing element relative to the second housing element toward the deployed orientation, as the flexible material is wound upon itself about an axis of rotation defined by the torsional member.

17. The foldable electronic device of claim 1 wherein the biasing member comprises a torsional member having a first end fixed to one of the first housing element and the second housing element, and a second end coupled to a pinion, the other of the first housing element and the second housing element having a rack coupled thereto, wherein the rack corresponds to the pinion, the torsional member biasing the pinion to translate the rack, whereupon such translation rotates the first housing element relative to the second housing element toward a deployed orientation.

18. The foldable electronic device of claim 1, further comprising a closure assembly having a first closure member disposed on the first housing element and a second closure member disposed on the second housing element, the first closure member positioned so as to releasably engage the second closure member upon rotation of the first housing element and the second housing element about the linkage assembly to place the inward surface of the first housing element and the inward surface of the second housing element in an overlying orientation, defining a closed orientation, wherein the cooperation between the first closure member and the second closure member is sufficient to oppose the biasing member and releasably maintain the first housing element and second housing element in the closed orientation.

19. The foldable electronic device of claim 18 wherein the first closure member comprises at least one magnet and the second closure member comprises at least one magnet, positioned so as to correspond with the at least one magnet of the first closure member upon positioning of the first housing element and the second housing element into the closed orientation.

20. The foldable electronic device of claim 19 wherein each of the first closure member and the second closure member comprise a plurality of corresponding magnets.

21. The foldable electronic device of claim 18 wherein the first closure member comprises a latch member and the second closure member comprises a post member, the latch member and the post member releasably engaging each other upon positioning of the first housing element and the second housing element into the closed orientation, wherein one of the latch member and the post member are movable relative to the other so as to facilitate disengagement of the latch member and the post member.

22. The foldable electronic device of claim 1 wherein the linkage assembly further includes an inward limiting member defined by the interaction of a portion of adjoining walls of adjacent links.

23. A coupling assembly for a foldable electronic device, comprising:
a linkage assembly comprising a plurality of adjacently disposed links collectively defining a first end and a second end, the first end is coupled to a first housing element of a foldable electronic device and the second end is coupled to a second housing element of a foldable electronic device to, in turn, enable relative rotation of a first housing element of a foldable electronic device and a second housing element of a foldable electronic device thereabout, each link is rotatably coupled to each adjacently disposed link, each link includes an outward limit member limiting relative rotation of adjacent links in an outward direction of rotation, whereupon engagement of the outward limit members precludes further rotation, defining a deployed orientation; and
a biasing member coupled to a first housing element of a foldable electronic device and coupled to a second housing element of a foldable electronic device, the biasing member outwardly biasing a first housing element of a foldable electronic device relative to a second housing element of a foldable electronic device so as to direct rotation of a first housing element of a foldable electronic device relative to a second housing element of a foldable electronic device about the linkage assembly toward the deployed orientation, wherein the biasing member includes an operable length which changes as the first housing element is rotated relative to the second housing element toward the deployed orientation.
